(19) United States
(12) Patent Application Publication
(10) Pub. No.: US 2014/0056653 A1
(43) Pub. Date: Feb. 27, 2014

(54) Method and Machine for Filling 3D Cavities with Bulk Material

(71) Applicants: Christopher Scully, Troy, NY (US); Asa T. Snyder, Machanicville, NY (US); Cameron M.L. Churchill, Troy, NY (US); Ian Brondol, Troy, NY (US); Eben Bayer, Troy, NY (US)

(72) Inventors: Christopher Scully, Troy, NY (US); Asa T. Snyder, Machanicville, NY (US); Cameron M.L. Churchill, Troy, NY (US); Ian Brondol, Troy, NY (US); Eben Bayer, Troy, NY (US)

(21) Appl. No.: 13/972,185

(22) Filed: Aug. 21, 2013

Related U.S. Application Data
(60) Provisional application No. 61/691,876, filed on Aug. 22, 2012.

(51) Int. Cl. B65G 53/44

(52) U.S. Cl. CPC B65G 53/44
USPC 406/78; 198/610

(57) ABSTRACT

The machine and method employ a moving fluid, either a gas or liquid that is moved through a three-dimensional cavity of a form covered in part with a filter material. The filler material is introduced to the fluid stream and is deposited in the three-dimensional cavity of the form as the moving fluid is filtered from the stream by the filter material.

This application claims the benefit of U.S. Provisional Patent Application 61/691,876 filed Aug. 22, 2012.

This invention relates to a method and machine for filling three-dimensional cavities in forms with bulk material. More particularly, this invention relates to a method and apparatus for filling trays with bulk biologically sensitive material.

### BACKGROUND OF THE INVENTION

In the production of shaped products made from the binding of various organic or inorganic particles or fibers by filamentous fungi, there currently exists a need to fill a non-perforated thermoformed plastic form with a variety of materials in a sanitary fashion. The form must be filled homogeneously in terms of density, with a smooth top surface.

As is known, conventional methods of depositing a bulk material into three dimensional cavities of a form are unable to handle fibrous or semi-wet particulate materials in a sanitary and efficient fashion. Conveyance by vibration, pistons, screw augers, and belts all have limitations in sanitary filling applications in regards to materials with varying density, cohesiveness, adhesiveness, fiber length, particulate size, and other mechanical variables.

There are many challenges inherent to filling three dimensional forms with difficult materials, especially damp, sticky, or fibrous materials. Because these types of materials have a tendency to clump, bind, or form fibrous ropes when conveyed, the use of vibratory or other mechanical means makes it difficult to achieve all of the desired fill characteristics (including desired density, uniform density, and uniform surface finish). Current equipment exists that can move bulk materials, and fill certain forms, but very little exists in the current state of the art that can handle a wide variety of materials and fill a wide variety of cavity shapes in a sanitary fashion.

Previous approaches to the filling of an open-topped cavity of a form include packing the cavity manually, and using vibratory action to flow material into the cavity. Manual packing is both slow and labor intensive, and leads to inconsistent packing densities both within and among parts. Vibratory action leads to issues with clumping and compaction in sticky and/or fibrous materials. Simply dropping material into an open top cavity results in unreliable top surface consistency, density, and finish. Using brushes or smooth gates to level off the top surface of a filled cavity results in material rolling and tearing, especially with fibrous materials.

Various types of conveyors have also been known for moving light weight synthetic materials from place to place, for example, pneumatic conveyors such as described in U.S. Pat. Nos. 6,035,606 and 6,497,031. Typically, the techniques employed with these conveyors packs the light weight synthetic materials into mesh-like expandable tubes.

Accordingly, it is an object of the invention to provide a simple efficient technique for filling open-topped forms with a fill material of biologically sensitive material.

It is another object of the invention to efficiently fill 3D cavities of forms with materials that are too fibrous to be handled by existing methods.

It is another object of the invention to efficiently fill 3D cavities of forms with materials that are too damp or wet to be handled by existing methods.

It is another object of the invention to efficiently fill 3D cavities of forms with materials that are prone to twisting or “roping” for existing methods.

It is another object of the invention to provide a method of filling 3D cavities of forms with biologically sensitive material that is gentle enough to minimize damage to the material.

It is another object of the invention to provide a method of filling 3D cavities of forms with biologically sensitive material that is sufficiently sanitary to minimize contamination of the material.

It is another object of the invention to be able to modulate the density of a material delivered into a 3D cavity of a form.

### BRIEF SUMMARY OF THE INVENTION

Briefly, this invention provides a machine and method that conveys a fill material into cavities of forms under a negative pressure, which leads to uniform compaction to the desired density, with surface uniformity governed by a filter material used to close over the form and to allow for the extraction of air from the form.

In particular, the invention provides a machine and method to move bulk biologically sensitive material into a 3D cavity of an open-topped form. In particular, the bulk biologically sensitive material is a mass of living fungal tissue, such as made in accordance with the methods described in pending U.S. patent applications Ser. No. 12/001,556, filed Dec. 12, 2007, Ser. No. 13/411,877 filed Mar. 5, 2012 and Ser. No. 13/454,856 filed Apr. 24, 2012.

In one embodiment, the invention provides a machine that has a material supply station, a filling station and a closing station.

The material supply station includes a supply conveyor for delivering a mass of living fungal tissue to be deposited in the filling station.

In addition, the machine has a conveyor for conveying a series of open-topped forms,in a sequential manner along a predetermined path to the filling station.

The filling station is constructed so that the conveyor on which the forms are delivered can pass through to allow the forms to be sequentially filled with material. In addition, the filling station has a cover means for covering a first portion of the form being filled with material in the filling station, a means adjacent the cover means for conveying a stream of material into a second portion of the form for completely filling the form and an endless belt for covering a third portion of the form and for smoothing the material filled into the form.

The cover means employed in the filling station may be a stationary plate or an endless belt.

In a preferred embodiment, the means for conveying a stream of material includes a pneumatic conveyor for conveying an air-laden stream of material into the second portion of the form while the endless belt over the third portion of the form is perforated, for example, being made of filter material, to allow for the passage of air therethrough from the form. In addition, a plenum chamber is disposed within the perforated endless belt in communication with the third portion of the form and a vacuum line is disposed in communication with the plenum chamber for drawing air therefrom and from the third portion of the form.

The use of an air flow allows the material to be handled in a gentle manner while, at the same time, the air flow allows the material to be distributed throughout the entire three-dimensional cavity of the form being filled and packed in a uniform manner.

The closing station is located downstream of the filling station for placing a lid on each form after filling thereof. To this end, the conveyor for conveying the series of open-topped forms also passes through the closing station so that lids may be placed on the material-filled forms sequentially.

In still another embodiment, use may be made of a cleated conveyor belt to transfer material from the material supply station mechanically rather than pneumatically to a form in the filling station. In this embodiment, the material is conveyed on the top of the cleated conveyor belt while being guided by two sidewalls to the top opening of a form in the filling station. The material is added to the air stream being drawn into a form at a “fill inlet”, moved into the cavity of the form by the air being drawn from the form and then filtered by the perforated belt as the air passes through the belt.

The cleats of the conveyor belt introducing the material to the cavity of a form simultaneously carry the material across the cavity and sweep away any excess material that extends above the cavity surface into a bin or a vacuum recycling system for re-use.

The invention also provides a method for moving bulk biologically sensitive material into open-topped forms.

In accordance with the invention, a moving fluid, either a gas or liquid, is moved through a three-dimensional cavity of a form covered in part with a filter material. The filler material is introduced to the fluid stream and is deposited in the three-dimensional cavity of the form as the moving fluid is filtered from the stream of material by the filter material thereby allowing the filler material to completely fill the form.

In the case of a liquid, such as water or other suitable liquid, nutrients may be added to the liquid to aid in the growth of the fungal material, and/or a gelling agent may be added to the liquid to assist in the cohesion of the material in a form.

The method of the invention provides a fast, sanitary, and homogeneous fill for a variety of 3D cavity geometries and is able to handle a wide variety of materials with varying mechanical properties.

By using a fluid to move the material, the fluid used to convey the material may be filtered or sanitized to achieve sanitary conveyance. Relatively fragile materials can be moved in this way such as living fungal tissue to maintain desired biological viability due to the elimination of excessive mechanical strain.

In one embodiment, the method employs the steps of conveying a form having an open top along a predetermined path to a filling station; covering a first portion of the form in the filling station, conveying a stream of material into a second portion of the form and covering a third portion of the form while simultaneously extracting air from the form to completely fill the form with the material.

These and other objects and advantages of the invention will become more apparent from the following detailed description taken in conjunction with the accompanying drawings wherein:

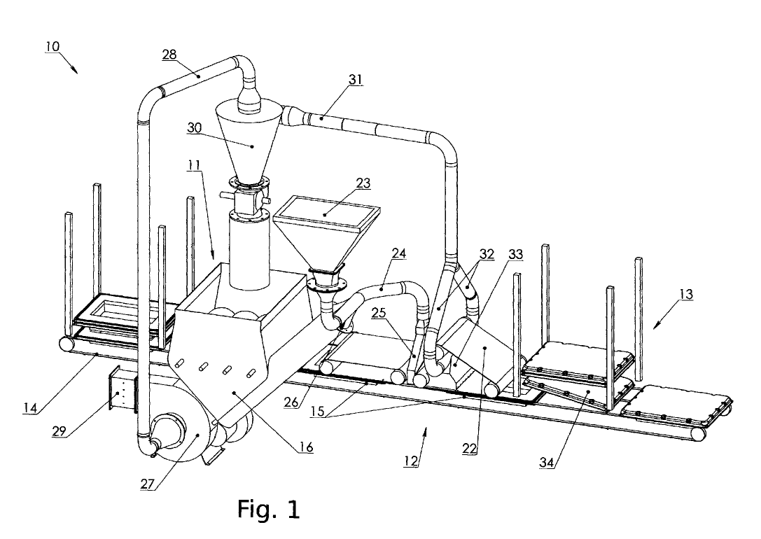

FIG. 1 illustrates a schematic view of a machine in accordance with the invention;

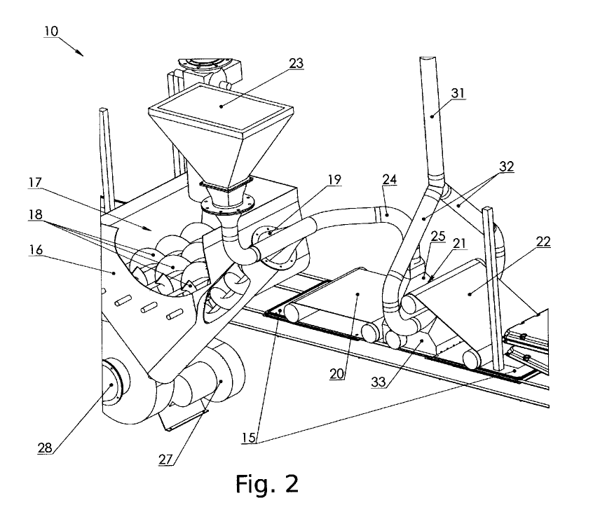

FIG. 2 illustrates an enlarged schematic view of the filling station of the machine of FIG. 1;

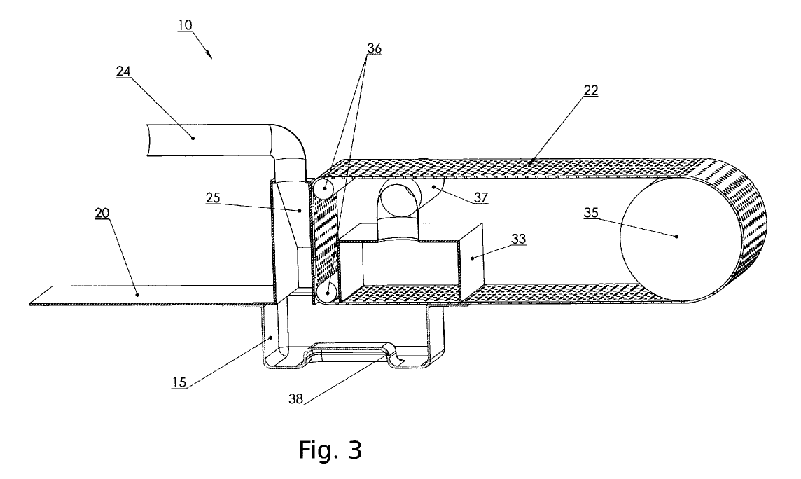

FIG. 3 illustrates a schematic view of a modified filling station in accordance with the invention;

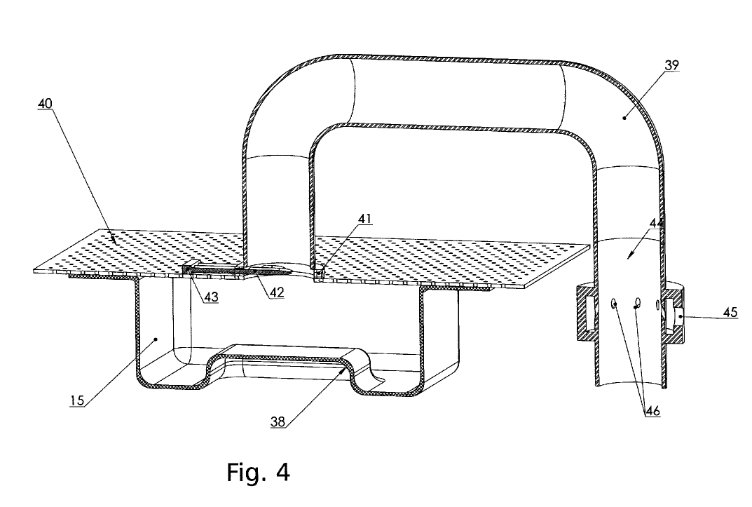

FIG. 4 illustrates a schematic view of a modified filling station in accordance with the invention; and

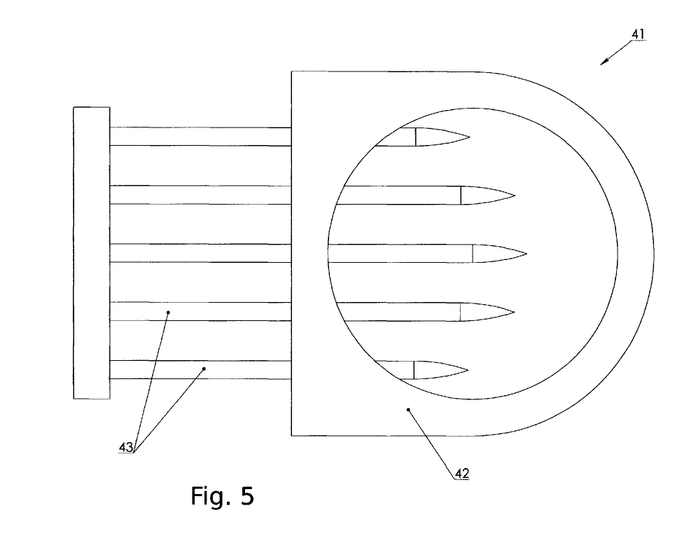

FIG. 5 illustrates a top view of a pin gate to regulate the flow of material in the filling station of FIG. 41; and

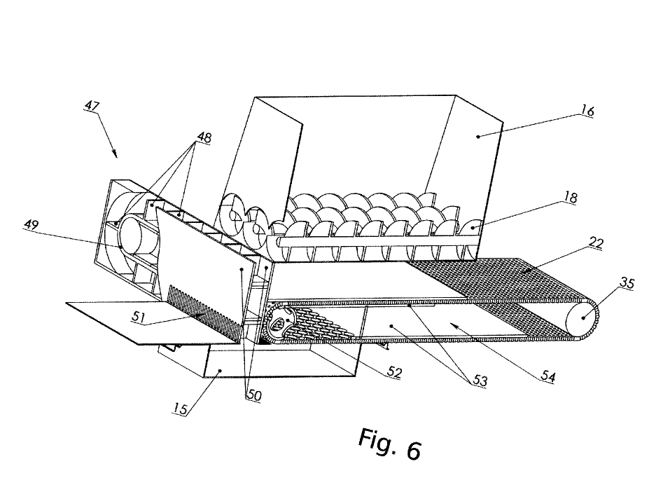

FIG. 6 illustrates a schematic perspective view of a modified machine in accordance with the invention.

Referring to FIG. 1, the machine 10 has a material supply station 11, a filling station 12 and a closing station 13. In addition, the machine 10 has a conveyor 14 for conveying a series of open-topped forms 15 in a sequential manner along a predetermined path to the filling station 12 as well as the closing station 13.

Referring to FIGS. 1 and 2, the material supply station 11 includes a hopper 16 for receiving a mass of bulk biologically sensitive material, i.e. a mass of living fungal tissue, (not shown) as referenced above as well as a supply conveyor 17 for delivering the mass of living fungal tissue to be deposited in the filling station 12. As illustrated, the supply conveyor 17 is in the form of parallel screw augers 18 in the bottom of the hopper 16 that convey the material out of an opening 19 in the side of the hopper 16.

Referring to FIGS. 1 and 2, the filling station 12 has a cover 20 for covering a first portion of a form 15 being filled with material in the filling station. This cover 20 may be an endless belt, as shown, that engages the top of a form 15 and moves therewith or a stationary plate under which the form 15 may slide past.

The filling station 12 also has a means 21 adjacent the cover 20 for conveying a stream of material into a second portion of the form 15 for completely filling the form 15 and an endless belt 22 of filter material for covering a third portion of the form 15 and for smoothing the material filled into the form 15.

As illustrated, the means 21 includes an air intake box 23 extending above the machine 10, a duct 24 extending from the air intake box 23 and a diffuser outlet 25 at the end of the duct 24 positioned directly above the form 15 at a “fill inlet” to the form 15 in the filling station. In addition, this means 21 has an inlet tube 26 communicating the opening 19 in the side of the hopper 16 with the duct 24 for delivering the living fungal tissue from the hopper 16 into the duct 24.

The means 21 also includes a suction blower 27 having an intake duct 28 for drawing in a flow of air and an exhaust duct 29. As illustrated, the intake duct 28 extends upwardly to communicate with the open end of a cyclone separator 30 in order to draw air therefrom and to create a partial vacuum therein.

By way of example, the blower 27 is a Series 20 general industrial fan made by New York Blower Company. The blower 27 is rated to pull 20 inches of water and is operated in accordance with the invention to pull from 8 inches to 15 inches of water in the forms 15.

In addition, a second duct 31 communicates with the interior of the cyclone separator 30 in order for air to be drawn from the duct 31. The end of this duct 31 is bifurcated into a Y-shape with two legs 32 that communicate with opposite ends of a plenum 33 located within the endless belt 22 of filter material.

With the suction blower 27 operating, air is drawn through the intake duct 28, cyclone separator 30, second duct 31 and plenum 33. As a result of the reduced pressure within the plenum 33, air is drawn through the filter material of the endless belt 22 from the form 15. As a result of the reduced pressure within the form 15, air is drawn from the diffuser outlet 25 and duct 24 thereby causing air to be drawn in from the air intake box 23 and material from the hopper 16 via the inlet tube 26.

The use of an air flow allows the material to be handled in a gentle manner while, at the same time, the air flow allows the material to be distributed throughout the entire three-dimensional cavity of the form 15 being filled and packed in a uniform manner.

The closing station 13 is located downstream of the filling station 12 for placing a lid 34 on the form 15 after filling thereof. To this end, the conveyor 14 for conveying the series of open-topped forms 15 also passes through the closing station 13 so that lids 34 may be placed on the material-filled forms sequentially.

The conveyor 14 is of any suitable type, such as an endless belt with cleats (not shown) thereon, for example, for indexing on the front end or lip on a form 15 to pull the form along or for pushing a form 15 therewith.

The form 15 may be of any suitable type and material, such as thermoformed plastic molds, trays and the like. The form 15 may also be of any suitable size with a typical size of 20 inches by 20 inches with cavities of from 0.05 to 0.33 cubic feet. Other sizes include 24 inches by 48 inches and sizes in between.

The method for moving the bulk biologically sensitive material into a series of forms 15 thus comprises the steps of conveying a form 15 having an open top along a predetermined path to the filling station 12. Thereafter, covering a first portion of the form 15 in the filling station 12 while extracting air through a covered third portion of the form 15 in order to cause a conveyance of a stream of material pneumatically into a second portion of the form 15 for completely filling the tray.

In this application, the machine 10 fills the open-topped form 15 by interfacing a filter surface, i.e. endless belt 22 of filter material, with the open side of the form 15 and creating a region of lowered pressure on the ex-form side of the filter surface. Also interfaced with the open side of the form 15 is a “fill inlet” which is not filtered. The differential of pressure causes a fluid flow that is capable of carrying a desired material through the “fill inlet” into the form 15. The filter surface 22 prevents the desired material from escaping the form 15. The form 15 can be filled to a specific density based on the pressure difference and material velocity when entering the cavity of the form 15.

The material fills the form 15 from the front to the back as the form 15 passes under the “fill inlet” below the diffuser 25. When the form 15 has passed completely under the “fill inlet” the screw augers 18 stop feeding, and the form continues to advance along the filter belt 22. A plastic lid 34 is then applied at the closing station 13. A fully filled and lidded form with a smooth top surface comes out the end of the machine 10 and proceeds to an incubation rack (not shown).

A preferred embodiment of this invention uses a moving perforated conveyor belt 22 as the filter material and air as the conveyance fluid. A form 15 with an open-top cavity is moved under the belt 22 in such a manner as to eliminate relative motion between the top surface of the form 15 and the filter belt 22. Air is removed from the cavity of the form 15 by the blower 27 removing air from the vacuum plenum 33 inside of the perforated belt 22.

Referring to FIG. 3 wherein like reference characters indicate like parts as above, the filling station 12 may employ an endless-perforated belt 22 that passes about a drive roller 35 at one end and a pair of guide rollers 36 at the opposite end while defining a rectangular-shaped opening in which the plenum 33 is mounted. As illustrated, the guide rollers 36 are disposed vertically over each other so that the run of the belt 21 therebetween is vertically disposed in parallel to and at a slight spacing from the diffuser 25.

The plenum 33 is open at the bottom and communicates with a single duct 37 at the top, as viewed, that, in turn, communicates with the duct 31 (see FIG. 2) to the cyclone separator 30 (see FIG. 2).

As illustrated in FIG. 3, the form 15 has a recessed base 38 to impart a particular shape to the finished product.

Referring to FIG. 4, wherein like reference characters indicate like parts as above, the filling station 12 may be modified to use a positively pressurized fill inlet line 39 and a perforated form top formed by a plate 40.

As illustrated, the fill inlet line 39 has a material pickup inlet at a lower end, as viewed, and carries a shut-off gate 41 at the outlet that rests against the plate 40.

Referring to FIGS. 4 and 5, the shut-off gate 41 includes a support ring 42 secured to the inlet line 39 and a plurality of pins 43 that are mounted in the support ring 42 to reciprocate back and forth to open and close the opening in the support ring 42 to the flow of material. Any suitable control means (not shown) may be used to program the opening and closing of the shut-off gate 41.

The pins 43 may enter from one or both sides, or radially, of the support ring 42.

Alternatively, use may be made of an iris valve or a gate valve.

There may be more than one inlet line per form 15.

The motive power for the fluid conveyance is provided by an inline air multiplier 44 having a compressed air inlet 45 and that communicates with the interior of the inlet line 35 via multiple ports 46. Also, fluid conveyance may be provided by a blower that draws the air from the perforated form (cavity) top, or a combination of the two methods.

The filter plate 40 may be fully or partially perforated. In the case of partial perforations, the perforations may take the form of a ring surrounding the inlet, the outline of the cavity, or some other morphology.

Referring to FIG. 6, wherein like reference characters indicate like parts as above, the material to be filled into a tray 15 may be conveyed from the hopper 16 mechanically rather than pneumatically.

For example, as illustrated, a mechanical conveyor 47 having spaced apart cleats 48 on an endless belt 49 for depositing a sequence of charges of material at the filling station may be positioned directly under the hopper 16 to receive the material between successive cleats 48. In addition, the conveyor 47 is positioned to travel transversely over and across a form 15 at the filing station in order to sequentially dump material into the form 15 as the lower run of the belt 49 passes over the form 15.

During operation of the mechanical conveyor 47, material is guided by two sidewalls 50 of the conveyor 47 while being carried in the “pockets” defined by the cleats 48 around to the top surface of the form 15. The material is added to the air stream at the fill inlet, where the material is moved into the cavity of the form 15 by the air and then filtered by the filter belt 22. The cleats 48 introducing the material to the cavity air stream simultaneously carry the material across the cavity surface and sweep away any excess material that extends above the cavity surface into a bin or a vacuum recycling system for re-use.

As illustrated, one of the sidewalls 50 of the conveyor 47 may have air infeed slots 51 along a lower end in alignment with the “fill inlet” to the form 15 in order to facilitate the delivery of material into the form 15.

Also, the filter belt 22 may pass over a drive roller 35 at one end and a hollow perforated roller 52 at the opposite end through which air may be drawn. As shown, a pair of un-perforated horizontal plates 53 connected with a pair of un-perforated vertical plates (sidewalls) (not shown) are disposed within the belt 22 to form an ambient air chamber 54 with the lower plate 53 spaced from the perforated roller 52 to define a passageway for air from the form 15 through the belt 22 and into the roller 52. The ambient air chamber 54 may also be open to the ambient environment outside the machine.

Various modifications may be made to the machine and method described above.

### Variations in Method

Filling using a stationary form and a stationary fill head. (form moves to a location under the fill head, material is injected into the form and the form moves away from the fill head)

Filling using a moving form and a stationary perforated surface. The form may move in 1, 2, or 3 dimensions as the form moves relative to the fill head. (same as above, but the form is moving relative to the fill head while the material is being injected) For example, the form moves such that the material inlet traces the periphery of the cavity of the form during the filling.

The perforated fill plate may have multiple fill tubes for the introduction of material. This allows for either multiple fill points for a single cavity, or the simultaneous fill of multiple cavities.

Filling using a moving fill surface and a moving cavity. This presents no relative movement to the surface of the cavity being filled.

By way of example, the machine and method may be modified to conduct batch filling of stationary trays. Other techniques may employ:
continuous filling using a moving tray and a stationary perforated surface.
using a filter material surface, such as a paper filter, that may remain on the surface and provide a material that mycelium might grow through, becoming an integral part of the finished part. This filter may or may not be backed up by a perforated belt or other support.
a filter surface with topography that will leave the part formed in a tray with a sculpted surface
a filter surface designed to leave indentations or projections.

The orientations of the filter surface and form may be changed, e.g. filter surface on top, on bottom, on sides.

The fill head designs may be:
1. Single fill head open over the width of a moving form
2. Divided fill head over the width of the form with a single inlet
3. multiple fill ports with multiple pickups
4. single moving fill port with single fill pickup
5. single or multiple fill ports feeding different materials to create a striated fill (could be striated in either of 2 orientations, or applied in a checkerboard pattern)
6. Vibratory conveyance and settling.

Vibratory conveyance, coupled with a surface smoothing step consisting of a perforated plate applied to the filled surface, with a vacuum then being applied to portions of the surface in turn.
7. multiple low pressure areas: a single belt, or multiple belts

### Modified Process Steps:

A source of agriculture byproducts inoculated or colonized by a fungal tissue dispenses material into a hopper 16 (as shown in FIG. 1). A stack of open top forms 15, such as plastic trays, are placed on a tray handling mechanism which dispenses a tray onto a pair of guide rails (not shown). The tray is then conveyed underneath a fill head mechanism (24 as in FIG. 1), the first part of which is a sealing plate or belt 19 (as in FIG. 1) which forms an air seal with the top surface of the tray thereunder. The tray continues to move under the fill head mechanism until the cavity space of the tray reaches the filter belt 22 (FIG. 1) which surrounds a vacuum plenum 33. The plenum 33 is then negatively pressurized by a blower 27, which causes air to be removed from the tray cavity through the filter belt 22. As air is sucked from the cavity of the tray, air rushes in through the fill head air and substrate inlet which can be filtered upstream by a HEPA filter. Material from the hopper 16 is then introduced into the moving airstream by screw augers 18. The mixture of material and air flows through the cavity of the tray until being filtered out of the airstream by the filter belt 22 which moves at the same speed as the tray 15.

Methods for Introducing Material into the Airstream:

The fill methods outlined above require the filling material to be introduced into the airstream for filling. The following methods have been developed:
Rotary table: the fill material is deposited onto a rotating table. A spreader conditions the material into a thin layer or line as the table turns. A fill tube is positioned to pull the material off the table. Any material that is not picked up into the airstream recirculates back through the spreader to pass by the fill tube pickup again.
Tumble-drum: The material is placed into a cylinder like a cement mixer that rotates. The cylinder is open at one or both ends. The fill tube pickup is positioned to extend into the cylinder (drum). The cylinder rotates and tumbles or drops material in front of the fill tube, which pulls the material into the airstream. If open at one end, the cylinder may be inclined such that the material will not fall out of the open end. If open at both ends, the cylinder may have internal flighting to draw the material toward the center and prevent the material from migrating to and falling out of the ends.
Inclined cleated conveyor: This method consists of a cleated conveyor enclosed in a hopper. The hopper is filled with material until the material rises above the lowest level of the cleated conveyor, but is below the highest level. The fill tube is positioned above the cleated belt, such that as the belt conveys material past the fill tube, and any material that is not drawn into the tube is returned to the hopper as the material falls off the end of the belt.

The invention thus provides a simple efficient technique for filling open-topped forms with a fill material of biologically sensitive material.

The invention further provides a machine to efficiently fill 3D cavities of forms with materials that are too fibrous to be handled by existing methods or too damp or wet to be handled by existing methods or that are prone to twisting or “roping” for existing methods.

The invention also provides a machine and method of filling 3D cavities of forms with biologically sensitive material that are gentle enough to minimize damage to the material and sufficiently sanitary to minimize contamination of the material.

The invention also provides a machine and method that are able to modulate the density of a material delivered into a 3D cavity of a form.

What is claimed is:

1. A machine comprising
a conveyor for conveying a form having an open top along a predetermined path to a filling station;
a cover at said filling station for covering a first portion of the form in said filling station;
means adjacent said cover for conveying a stream of material into a second portion of the tray in said filling station adjacent to said first portion under a negative pressure for completely filling the form; and
an endless belt in said filling station for covering a third portion of the form and for smoothing the material filled into the form.

2. A machine as set forth in claim 1 wherein said cover is a stationary plate.

3. A machine as set forth in claim 1 wherein said cover is an endless belt.

4. A machine as set forth in claim 1 wherein said means adjacent said cover is a pneumatic conveyor for conveying an air-laden stream of material into said second portion of the form in said filling station and said endless belt is perforated for the passage of air therethrough from the form.

5. A machine as set forth in claim 4 further comprising a plenum chamber within said perforated endless belt and in communication with the third portion of the form in said filling station and a vacuum line in communication with said plenum chamber for drawing air therefrom and from the third portion of the form.

6. A machine as set forth in claim 1 further comprising a supply station including a supply conveyor for delivering a mass of living fungal tissue to form the stream of material conveyed to said filling station.

7. A machine as set forth in claim 6 wherein said means adjacent said cover is a pneumatic conveyor for receiving a mass of living fungal tissue from said supply conveyor and a stream of air for conveying the mass of fungal tissue into said second portion of the form in said filling station in a continuous stream.

8. A machine as set forth in claim 6 wherein said means adjacent said cover is a mechanical conveyor having spaced apart cleats for depositing a sequence of charges of material at said filling station.

9. A machine as set forth in claim 1 further comprising a closing station downstream of said filling station for placing a lid on the form after filling thereof.

10. A method for moving bulk biologically sensitive material into forms with at least one three-dimensional cavity, said method comprising the steps of
conveying a form having an open top along a predetermined path to a filling station;
covering a first portion of the form in said filling station;
moving a stream of fluid through the form in said filling station;
conveying a stream of material into a second portion of the form in said filling station adjacent to said first portion of the form and into said stream of fluid;
covering a third portion of the form; and
filtering said stream of fluid from the form while simultaneously completely filling the form with the material.

11. A method as set forth in claim 10 wherein said step of conveying a stream of material into a second portion of the form includes pneumatically conveying an air-laden stream of material into said second portion of the form while exhausting air from the third portion of the form.

12. A method as set forth in claim 11 wherein said step of covering a third portion of the form includes passing the form under a moving perforated endless belt while extracting air from the form through the perforated belt.

13. A method as set forth in claim 10 wherein said step of covering a third portion of the form includes passing the form under a moving perforated endless belt.

14. A method as set forth in claim 10 further comprising the step of placing a lid on the form after filling thereof in a closing station downstream of the filling station.
